(19) United States
(12) Patent Application Publication
(10) Pub. No.: US 2015/0025961 A1
(43) Pub. Date: Jan. 22, 2015

(54) METHOD AND SYSTEM FOR ONLINE MARKETING MEASUREMENTS

(71) Applicant: Matthijs JORISSEN, Hilversum (NL)

(72) Inventor: Matthijs JORISSEN, Hilversum (NL)

(73) Assignee: BUSINESS DEVELOPMENT COMPANY B.V., Hilversum (NL)

(21) Appl. No.: 14/327,705

(22) Filed: Jul. 10, 2014

(30) Foreign Application Priority Data
Jul. 16, 2013 (NL) 2011176

(51) Int. Cl. G06Q 30/02

(52) U.S. Cl. CPC G06Q 30/0246
USPC 705/14.45

(57) ABSTRACT

Method and system for online marketing measurements relating to a web shop website and associated advertising websites. Item data related to items for sale from the web shop website is received, the item data is tagged and the tagged item data is disseminated to the associated advertising websites. Furthermore, sales data associated with an actual sale of an item is received from the web shop website, and view data including the tagged item data associated with a view on the associated advertising websites is received from the associated advertising websites. From the received sales data and view data a route is determined of consecutive touch-points on the associated advertising websites and web shop website resulting in the actual sale, and the contribution of each touch-point to the actual sale is calculated.

### FIELD OF THE INVENTION

The present invention relates to a method and system for webshops to determine the actual contribution of online advertisements. More in particular, the present invention relates to a method and system for online marketing measurements relating to a web shop website and associated advertising websites.

### PRIOR ART

Traditional web analytics systems assign the order to the last visits to determine the performance of an advertising channel (last-cookie method). However, most online sales are the results of many visits, from many advertising websites. Therefore, traditional analytics systems are not reflecting the real contribution attributable to the various advertising channels.

The non-prepublished patent publication WO2013/184588 discloses a system and method for allocating credit for an advertising conversion among various advertising touchpoints encountered by a consumer. The system and method comprise receiving data pertaining to touchpoints and conversions of an advertising campaign across multiple channels. Users are correlated across the channels and the various conversions, touchpoints, and touchpoint attributes are identified. Each touchpoint attribute and touchpoint attribute value is assigned a weight. An attribution algorithm is selected, and coefficients are calculated using the assigned weights. The algorithm is executed and true scores corresponding to the touchpoints encountered by each converting user are computed.

### SUMMARY OF THE INVENTION

The present invention seeks to provide an improved method and system to enable proper assessment and decision making based on data measured in the entire process resulting in a sale.

According to the present invention, a system is provided for online marketing measurements relating to a web shop website, comprising a tracking system and an ad-serving system in communication with a plurality of ad-serving engines, which are implemented as part of the functionality of associated advertising websites, both the tracking system and ad-serving system being in communication with the web shop website. The ad-serving system is arranged to receive from the web shop website item data related to items (products and/or services) for sale from the web shop website, to tag the item data and to disseminate the tagged item data to the ad-serving engines, and arranged to receive from the ad-serving engines view data including the tagged item data associated with a view on the associated advertising websites. The tracking system is further arranged to receive from the web shop web site sales data associated with an actual sale of an item, and to determine from the received sales data and view data a route of consecutive touch-points on the associated advertising websites and web shop website resulting in the actual sale, and to calculate the (actual) contribution of each touch-point to the actual sale. This ensures a proper calculation of the contribution of a route towards an eventual sale, using measured and determined parameters associated with touch-points along that route.

In a further embodiment, the communication received from the web shop web site is a one-way communication path to the tracking system and ad-serving system. This allows a simple and efficient implementation of the system without the need for complex resources to obtain the desired data.

The sales data comprises visit data associated with touch-points of the route of consecutive touch-points towards the web shop website in a further embodiment. Determining the route of consecutive touch-points may be executed in a further embodiment using the tagged item data received from the ad-serving engines and the web shop web site.

In an even further embodiment, calculating the contribution of each touch-point comprises: calculating a score using the formula Score(Tᵢ)=Sum(W_{y}*Factor_{y}), wherein Factor_{y} are factor values of a contributory factor relevant to the actual sale for the touch-point and W_{y} is a pre-determined associated weight factor. In an exemplary embodiment, the score is calculated using the formula

Score(Tᵢ)=W_{Rc}*Recency+W_{E}*Engagement+W_{R}*Relevance+W_{Q}*Quality

where Recency, Engagement, Relevance and Quality are factor values of the contributory factors for the touch-point Tᵢ, and W_{Rc}, W_{E}, W_{R}, W_{Q} are pre-determined weight factors for each associated factor. This allows to determine the effect of a sales channel, and the contributions to an actual sale using a limited number of parameters and measurements. In a further embodiment, e.g., the weight factors are determined by a logistic regression analysis using a dataset of historical sales data and view data.

To further scale the measurements and parameters of the present system, the factor values are translated in a scale of 1 to n, n being e.g. 5. In an even further embodiment, calculating the contribution of each touch-point further comprises calculating an assist contribution for each touch-point by dividing the score by the sum of scores of all assisting touch-points associated with the actual sale.

In a further aspect, the present invention relates to a method for online marketing measurements relating to a web shop website and associated advertising websites, comprising receiving item data related to items (i.e. products and/or services) for sale from the web shop website, tagging the item data and disseminating the tagged item data to the associated advertising websites, receiving from the web shop website sales data associated with an actual sale of an item, receiving from the associated advertising websites view data including the tagged item data associated with a view on the associated advertising websites, determining from the received sales data and view data a route of consecutive touch-points on the associated advertising websites and web shop website resulting in the actual sale, and calculating the contribution of each touch-point to the actual sale. In a further embodiment, calculating the contribution of each touch-point comprises calculating a score using the formula

Score (Tᵢ)=Sum(W_{y}*Factor_{y}), wherein Factor_{y} are factor values of a contributory factor relevant to the actual sale for the touch-point and W_{y} is a pre-determined associated weight factor. As an example, the score is calculated using the formula

Score(Tᵢ)=W_{Rc}*Recency+W_{E}*Engagement+W_{R}*Relevance+W_{Q}*Quality

where Recency, Engagement, Relevance and Quality are factor values of the contributory factors for the touch-point Tᵢ, and W_{Rc}, W_{E}, W_{R}, W_{Q} are pre-determined weight factors for each associated factor.

The weight factors may be determined by a logistic regression analysis using a dataset of historical sales data and view data. Furthermore, the factor values are translated in a scale of 1 to n, n being e.g. 5 in a further embodiment, to allow implementation of the present method with lower resource costs. Calculating the contribution of each touch-point may further comprise calculating an assist contribution for each touch-point by dividing the score by the sum of scores of all assisting touch-points associated with the actual sale.

### SHORT DESCRIPTION OF DRAWINGS

The present invention will be discussed in more detail below, using a number of exemplary embodiments, with reference to the attached drawings, in which

FIG. 1 shows a schematic drawing of a plurality of websites depicting a possible route to an Internet sale;

FIG. 2 shows a schematic diagram of a system for online marketing measurements according to an embodiment of the present invention; and

FIG. 3 shows an alternative example of the schematic drawing of FIG. 1.

### DETAILED DESCRIPTION OF EXEMPLARY EMBODIMENTS

The e-business market is growing fast. Intelligent online marketing is the key to success. E-business companies invest heavily in online marketing such as search engine marketing, affiliation, social media and display advertising. Online retailers typically advertise with all their products and offers on many advertising channels. As a result a retailer could have millions of advertisements published.

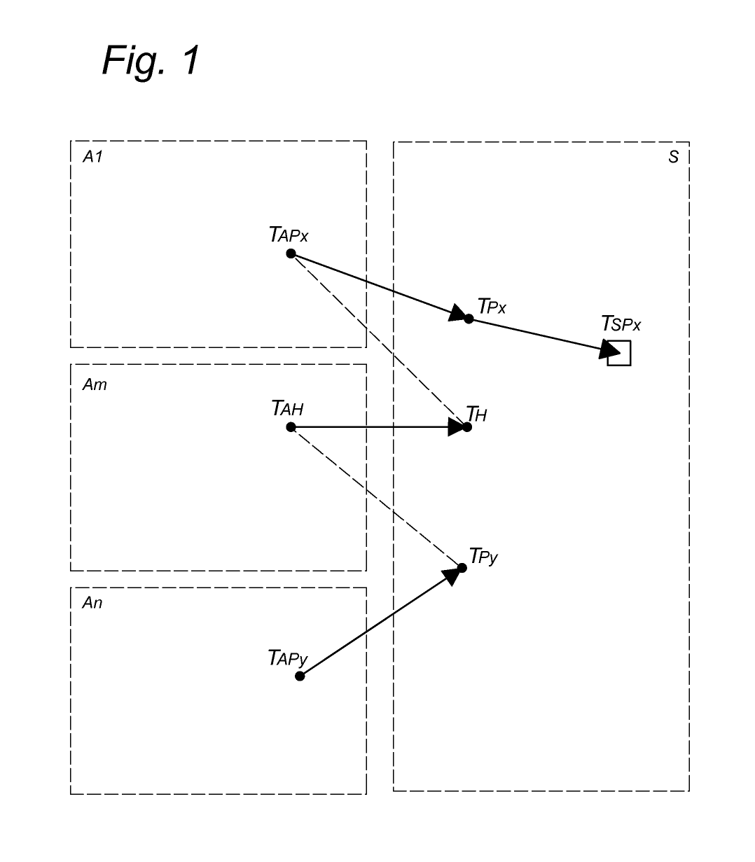

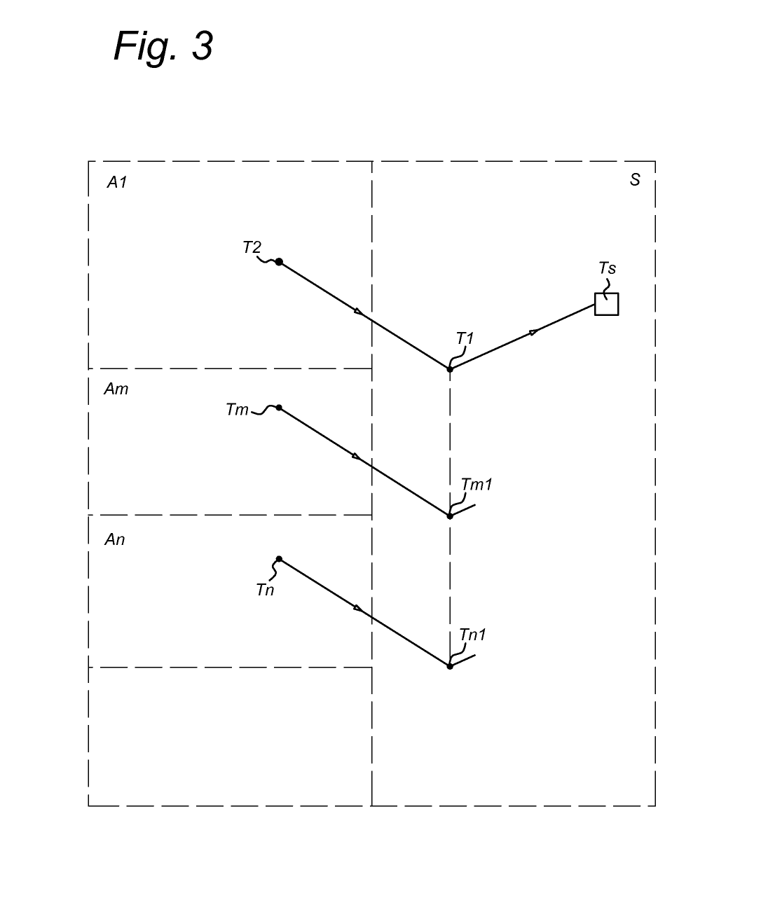

Every sale is the result of many “touch-points”, which may be a view of an advertisement or banner, a click on such an advertisement or banner provided with a link to a further touch-point in the route, etc., or even other advertisement channel visits. Also on the website of a web shop itself, multiple touch-points may be made before arriving at the actual sale activity. So, every sale is the result of many touch-points which each may show different behavior on the associated website. Each touch-point will have different characteristics (time on site, page(s) viewed, etc., see below) which are stored for each touch-point. An example of such a sequence or route of touch-points is schematically shown in FIG. 1, and an alternative example is shown in FIG. 3.

FIG. 1 shows a website S, which hosts a web shop with a sales system. To the left of website S, a plurality of advertising or linking websites Aᵢ (Aₗ, Aₘ, Aₙ) is shown. The eventual sale of a product (or service) x by the web shop S is shown as sales touch-point T_{SPx} (x is the product sold). The eventual sales touch-point T_{SPx} is reached via a route of previous product page touch-points T_{Px}, on the web shop S itself, and touch-points T_{APx} on website Aₗ (tagged with Px). Before touch-point T_{APx} on website Aₗ there were other visits from website Aₙ (at time t2) with touch-point T_{AH} and via website Aₘ (at time t1) with touch-point T_{APy}.

It is noted that a touch-point Tᵢ may comprise multiple page-views, however, information is recorded and retrieved as related to a single touch-point Tᵢ on a website Aᵢ.

In FIG. 3 an alternative example is shown. Here a situation is shown where a person eventually involved in an actual sale (touch-point Ts) has already visited the webshop website S before, and even via different routes: the earliest touch-point Tn1 originated from touch-point Tn on website An, and the subsequent touch-point Tm1 on webshop website S originated from touch-point Tm on website Am. In this example, it is possible, when an actual sale occurs on the webshop website S (tagged in association with touch-point Ts), to use the previous relevant touch-points T1, T2, but also Tm1, Tm and Tn1, Tn in the relevant calculations, thus allowing to provide more complete views on how an actual sale is eventually made. The touch-points Tn1, Tm1 and T1 on the webshop website S form a journey of the person eventually resulting in the sale of the item.

For the present invention embodiments, the specific type of advertising channel (i.e. advertising or linking website Aᵢ) can be any of present day or future possibilities for advertising or marketing a product or service, such as comparison sites, adwords, organic sites, affiliate networks, retargeting websites, email, portal websites, display websites, etc.

Traditional analytics systems measure the performance of advertising channels by assigning orders to the last visit, i.e. touch-point T_{APx} in the example shown in FIG. 1. This “last cookie” method does not show the contribution of the other touch-points T_{AH} and T_{APy}. As a result, online marketers are making decisions based on inaccurate or incorrect data, since the last touch-point is only a small part of the total customer journey.

The present invention embodiments calculate in real-time the actual contribution of each individual advertisement on Aₗ, Aₘ, Aₙ. The method is based on multiple factors including:
The recency of the visit (time between the visit and the sale);
The engagement of the visit (duration/page views/page type);
The relevance of the advertisements related to the sale;
The quality of the advertising channel.

In order to be able to collect the data needed for a proper calculation of the actual contribution of each individual touch-point, various characteristics need to be provided by the system for online marketing measurements and the web shop S. The functional units may be implemented as software programs or related instruction sets, e.g. included in the website environment as (a functional module) in dedicated software, an applet, etc.

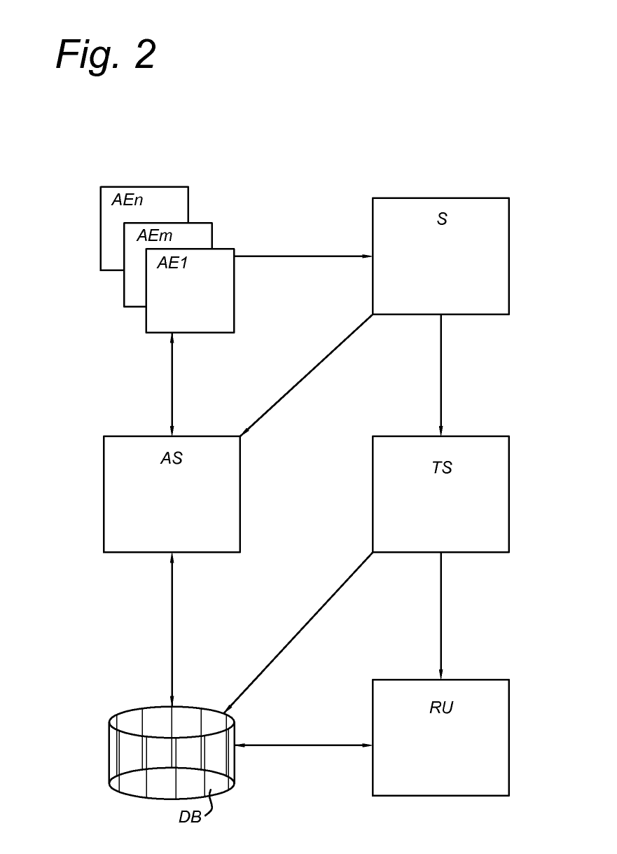

FIG. 2 shows a schematic diagram of the units and components involved in the system for online marketing measurements, and of the data exchange between these units and components. The central unit is the tracking system TS, in which the method embodiments which will be described below are implemented as data gathering and calculation steps. The tracking system TS collects the information with e.g. JavaScript's implemented on the web shop S. In order to track visits (touch-points T_{APx}, T_{AH}, T_{APy}), pageviews (touch-points T_{Px}) and orders (touch-points T_{SPx}) correctly, all the links should be tagged properly.

The proper tagging is provided by an ad-serving system AS that is in communication with and provides all the links and banners to a large number of ad-servicing engines AEᵢ (AEₗ, AEₘ, AEₙ), which may be implemented as part of the functionality of the advertising and linking websites Aᵢ (see FIG. 1). The tracking system TS and ad-serving system AS are also in communication with a database DB for storing (intermediate) data, and with a reporting unit RU, which may e.g. be used to display or print reports as output from the TS. The tracking system TS and ad-serving system AS can thus exchange information and data via the database DB, however, also direct communication may be implemented between the tracking system TS and ad-serving system AS.

Aspects of the present invention, and more specifically the functional units TS, AS, AEᵢ, S, etc., may be implemented with a distributed computer system operating environment that provides an instant messaging capability. In a distributed computing environment, tasks may be performed by remote computer devices that are linked through communications networks. The distributed computing environment may include client and server devices that may communicate cither locally or via one or more computer networks. Embodiments of the present invention may comprise special purpose and/or general purpose computer devices that each may include standard computer hardware such as a central processing unit (CPU) or other processing means for executing computer executable instructions, computer readable media for storing executable instructions, a display or other output means for displaying or outputting information, a keyboard or other input means for inputting information, and so forth. Examples of suitable computer devices include hand-held devices, multiprocessor systems, microprocessor-based or programmable consumer electronics, networked PCs, minicomputers, mainframe computers, and the like.

The method embodiment of the present invention will be described in the general context of computer-executable instructions, such as program modules, that are executed by a processing device, including, but not limited to a personal computer. Generally, program modules include routines, programs, objects, components, data structure definitions and instances, etc, that perform particular tasks or Implement particular abstract data types. Typically the functionality of the program modules may be combined or distributed as desired in various environments,

Embodiments within the scope of the present invention also include computer readable media having executable instructions. Such computer readable media can be any available media that can be accessed by a general purpose or special purpose computer. By way of example, and not limitation, such computer readable media can comprise RAM, ROM, EEPROM, CD-ROM or other optical disk storage, magnetic disk storage or other magnetic storage devices, or any other medium which can be used to store the desired executable instructions and which can be accessed by a general purpose or special purpose computer. Combinations of the above should also be included within the scope of computer readable media. Executable instructions com-so prise, for example, instructions and data which cause a general purpose computer, special purpose computer, or special purpose processing device to perform a certain function or group of functions.

The present invention embodiments rely on various data in relation to the route to the eventual sale T_{SPx}. To analyze the contribution of each advertisement or contributory channel Aᵢ, the traking system TS collects every view and visit prior to each order, i.e. data related to all touch-points T_{APx}, T_{AH}, T_{APy} in FIG. 1, as well as the sales data associated with touch-point T_{SPx}. To determine the relevance it is also necessary to obtain item data relating to the categorization of each product or service for sale of the web shop S. This information is collected by the ad-serving system AS with a data feed with the categorization of the products from the web shop S. Since orders could be cancelled or returned also information about order status is needed from the web shop S. This information in relation to net orders from back-office systems of the web shop S is received by the tracking system TS. These data flows are depicted in the schematic diagram of FIG. 2

In an exemplary embodiment, the following item data is collected by the tracking system TS in relation to the touch-point T_{APx}, T_{AH} and T_{APy}:

The cookie id; The IP and User Agent (optional); The date/time of the visit; The source (advertising channel, domain or publisher); The product; The duration and page views of the visit; The page_type (homepage, category page or product page)

For every order T_{SPx}, the following item data is collected by the tracking system TS:

The cookie id; The IP and User Agent (optional); The date/time of the order; The purchased products; The order value (optional); The account_id of the customer (optional);

Each link and banner in the route towards the sale T_{SPx} is properly tagged in order to be able to measure the relevant data associated with the visits and views properly. The ad-serving system AS is arranged to tag, merge and serve the content including the proper tagging. For this purpose the ad-serving system AS collects a single data feed from the web shops and distributes the properly tagged data feeds to the advertising channels AE₁-AEₙ. This categorization in the data feed is also used by the tracking system TS to determine the relevance of advertisements on the advertising web sites Aᵢ. If an advertisement does not match with the purchased products, the relevance depends on a category tree, as will be described in greater detail below.

The ad-serving system AS collects view data relating to the actual usage of the advertisement, i.e. relating to the touch-points T_{A3}, T_{A4}, T_{Am}, T_{An} in FIG. 1. For each of these touch-points T_{Ai}, the following view data is stored:

The IP and User Agent; The date/time of the view; The source (advertising channel, domain or publisher); The viewed product/banner; The category of the product (optional); The duration of the view (mouse-over).

To include the cancelled and changed orders in the analysis, the tracking system TS also collects the net orders from the web shop S. This is typically a list with order_id; account_id; order status; order_amount.

All the information gathered as described above is stored by the tracking system TS using the database DB.

In the present invention embodiments for the method for online marketing measurements, the tracking system TS is arranged to calculate the contribution of each touch-point prior to the order in real-time. When an order is registered at the web shop S, all the previous views and visits of that customer are collected based on e.g. cookie_ID and IP+User Agent. For each touch-point Tᵢ a score is calculated according to the formula:

Score(Tᵢ)=W_{Rc}*Recency+W_{E}*Engagement+W_{R}*Relevance+W_{Q}*Quality

where Recency, Engagement, Relevance and Quality are the factor values for that touch-point Tᵢ, and the Wₓ parameters are weight factors for each factor category. The weight factors are the result of a logistic regression analysis as described further below, are pre-determined and stored for use in the tracking system TS.

In order to allow for an efficient and real time calculation of scores Score (Tᵢ), the number of which may be very large, every value for the factors as gathered by the tracking system TS from the ad-serving system AS are translated into a ranking score. In an exemplary embodiment, every value is translated into a ranking score of 1 to 5.

For Engagement and Quality the ranking is derived by the tracking system TS by taking a dataset with over 10 million visits, sort the dataset on the dependent variables used to derive that factor from high to low and then divide the set into five equal parts. The range within these subsets fence off the range of the score for that variable. The subset with the highest range is the definition for the highest score and the subset with the lowest range is the definition for the lowest score. For Recency the same method is applied. For that factor sorting is applied from lowest to highest, since a lower Recency is more important than a higher Recency. The scores for Relevance are based on the category tree.

The recency of each touch-point is the time difference between the touch-point Tᵢ and the actual order T_{S}. This time difference or latency is translated into a scale from 1 to 5 based on 5 equal amounts of measurements. Based on over 10 millions of visits, a scale was developed for the Recency factor:

5: if the assist is within an hour of the order

4: if the assist is between 1 hour and 1 day before the order

3: if the assist is between 1 day and 3 days prior to the order

2: if the assist is between 3 days and 1 week prior to the order

1: if the assist is more the a week prior to the order

Of course different scales may be used, adapted to specific circumstances for a specific application.

The engagement scoring of each touch-point Tᵢ depends on e.g. the page type: on product pages the duration of the visit is used, on other pages the number of page views of a visit are used. This engagement is translated into a scale from 1 to 5 based on 5 equal amounts of measurements. Based on over 10 millions of visits, the following scale for the factor Engagement is used:

| Scale | other_pages | product_pages |
|---|---|---|
| 5 | Page views >= 5 | duration >= 60 seconds |
| 4 | Page views = 4 | duration < 60 seconds |
| 3 | Page views = 3 | duration < 45 seconds |
| 2 | Page views = 2 | duration < 30 seconds |
| 1 | Page views = 1 | duration < 15 seconds |

Again, a different scale may be used, adapted to specific circumstances for a specific application.

The relevance of a touch-point Tᵢ is defined by the position in a category tree. If a touch-point Tᵢ is a product advertisement and if the order contains the product, the ranking 5. If the purchased products are in the same category, the ranking is 4, etc. The Relevance scale is defined in an exemplary embodiment as follows:

5: product ad=product purchased

4. product ad=in the same category as the product purchased

3. product ad=in the same parent category as the product purchased

2. product ad=in the same main category as the product purchased

1. product ad=nor related to the product purchased

For this scale also different scale may be used, adapted to specific circumstances for a specific application.

Where Relevance, Recency and Engagement are variables unique for each visit, the Quality is a metric indicating the overall performance of the publisher (i.e. advertising website A) from which the visit originates. The quality of each touch-point Tᵢ is the ratio of visits and views that are involved in the orders, and could also be called the assist ratio. This assist ratio is translated into a scale from 1 to 5 based on 5 equal amounts of measurements. Based on over 10 millions of visits, the scale for the factor Quality is determined to be:

5: Assist ratio more >4%

4: Assist ratio >3, <=4

3: Assist ratio >2, <=3

2: Assist ratio >1, <=2

1: assist ration <=1%

Once again, for this scale also different scale may be used, adapted to specific circumstances for a specific application.

As stated above, in an embodiment of the present invention, four variables (or factors) are used to score each assist to an order (actual purchase). These variables are Relevance, Recency, Engagement and Quality. The contribution of each assist is calculated with the use of these variables, real-time at the moment an order is placed.

A key factor of the conversion attribution model which is implemented in the TAS 10 is the combination of the four factors and its associated weight settings. The weights between the factors are the results of an analysis of the factors in a logistic regression model based on historical data. The results could depend on the type of industry and type of advertising channels, and the analysis should therefore be done periodically. The combination of weights derived from the logistic regression model incorporate the factors Recency, Relevance, Engagement and Quality. The regression model predicts the likelihood of a visit turning into a sale.

Combining the four factors in the logistic regression model results in a set of weights which indicate the relation between the variables. These weights can be used for the real-time calculation of contribution.

In a next step of the present invention embodiments, the scores of each assist are calculated by the formula below, based on the ranking of the factors and the weight settings:

Score=W_{Rc}*Recency+W_{E}*Engagement+W_{R}*Relevance+W_{Q}*Quality

Since the contribution of all the assists (which could be originating from different advertising channels Aₗ, Aₘ, Aₙ for a single sale in touch-point T_{S}) is 100%, the score is used to calculate the contribution of each visit Tᵢ by using the following function:

Assists.Contribution=Assist.Score/Sum of the scores of all assists

The contribution of an advertisement is an essential value to determine the effectiveness of ads. A typical web shop S has millions of product advertisements online. Some are very effective, others have a negative return. The Cost Per Order (CPO) is an key performance indicator to determine the effectiveness of an advertisement. The CPO are costs of the advertisement are divided by the assigned orders. The Contributed Cost per Order (cCPO) includes the actual contribution to the orders.

Incorporating cCPO, the return on marketing investment (ROMI) of each touch-point Tᵢ could be calculated in a further embodiment using:

ROMI=((product_contribution_margin)−cCPO)/cCPO

First the total contribution margin for the order is calculated by aggregating the total_product_contribution_margin of all products bought for the order T_{SPx} in which the assist Tᵢ contributed. If this return is negative, the ad should be excluded.

The ROMI of each advertisement could be used to exclude ads from campaigns. With the present invention embodiments this could be done automatically to exclude the advertisement in AS from serving. Many online retailers could save 30% to 50% of their marketing budget by excluding product ads with a negative return.

It is noted that further factors could play a role in the online sales route, and in further embodiments, these factors are also included in the calculations by the TS 10 as described above, such as Time on Site, Visited pages, Time in page, Visit number, etc.

The present invention embodiments have been described above with reference to a number of exemplary embodiments as shown in the drawings. Modifications and alternative implementations of some parts or elements are possible, and are included in

the scope of protection as defined in the appended claims.

1. A system for online marketing measurements relating to a web shop website, comprising a tracking system and an ad-serving system in communication with a plurality of ad-serving engines, which are implemented as part of the functionality of associated advertising websites, both the tracking system and ad-serving system being in communication with the web shop website,
wherein the ad-serving system is arranged to receive from the web shop website item data related to items for sale from the web shop website, to tag the item data and to disseminate the tagged item data to the ad-serving engines, and arranged to receive from the ad-serving engines view data including the tagged item data associated with a view on the associated advertising websites,
and wherein the tracking system is further arranged to receive from the web shop web site sales data associated with an actual sale of an item,
to determine from the received sales data and view data a route of consecutive touch-points on the associated advertising websites and web shop website resulting in the actual sale, and
to calculate the contribution of each touch-point to the actual sale.

2. The system of claim 1, wherein the communication received from the web shop web site is a one-way communication path to the tracking system and ad-serving system.

3. The system of claim 1, wherein the sales data comprises visit data associated with touch-points of the route of consecutive touch-points towards the web shop website.

4. The system of claim 1, wherein determining the route of consecutive touch-points is executed using the tagged item data received from the ad-serving engines and the web shop web site.

5. The system of claim 1, wherein calculating the contribution of each touch-point comprises:
calculating a score using the formula
Score(Tᵢ)=Sum(W_{y}*Factor_{y})
wherein Factor_{y} are factor values of a contributory factor relevant to the actual sale for the touch-point and W_{y} is a pre-determined associated weight factor.

6. The system of claim 5, wherein the score is calculated using the formula
Score(Tᵢ)=W_{Rc}*Recency+W_{E}*Engagement+W_{R}*Relevance+W_{Q}*Quality
where Recency, Engagement, Relevance and Quality are factor values of the contributory factors for the touch-point Tᵢ, and W_{Rc}, W_{E}, W_{R}, W_{Q} are pre-determined weight factors for each associated factor.

7. The system of claim 5, wherein the weight factors are determined by a logistic regression analysis using a dataset of historical sales data and view data.

8. The system of claim 5, wherein the factor values are translated in a scale of 1 to n, n being e.g. 5.

9. The system of claim 5, wherein calculating the contribution of each touch-point further comprises calculating an assist contribution for each touch-point by dividing the score by the sum of scores of all assisting touch-points associated with the actual sale.

10. A method for online marketing measurements relating to a web shop website and associated advertising websites,
comprising
receiving item data related to items for sale from the web shop website, tagging the item data and disseminating the tagged item data to the associated advertising websites,
receiving from the web shop website sales data associated with an actual sale of an item,
receiving from the associated advertising websites view data including the tagged item data associated with a view on the associated advertising websites,
determining from the received sales data and view data a route of consecutive touch-points on the associated advertising websites and web shop website resulting in the actual sale, and
calculating the contribution of each touch-point to the actual sale.

11. The method of claim 10, wherein calculating the contribution of each touch-point comprises
calculating a score using the formula
Score(Tᵢ)=Sum(W_{y}*Factor_{y})
wherein Factor_{y} are factor values of a contributory factor relevant to the actual sale for the touch-point and W_{y} is a pre-determined associated weight factor.

12. The method of claim 11, wherein the score is calculated using the formula
Score(Tᵢ)=W_{Rc}*Recency+W_{E}*Engagement+W_{R}*Relevance+W_{Q}*Quality
where Recency, Engagement, Relevance and Quality are factor values of the contributory factors for the touch-point Tᵢ, and W_{Rc}, W_{E}, W_{R}, W_{Q} are pre-determined weight factors for each associated factor.

13. The method of claim 12, wherein calculating the contribution of each touch-point further comprises calculating an assist contribution for each touch-point by dividing the score by the sum of scores of all assisting touch-points associated with the actual sale.

14. The method of claim 11, wherein the weight factors are determined by a logistic regression analysis using a dataset of historical sales data and view data.

15. The method of claim 14, wherein calculating the contribution of each touch-point further comprises calculating an assist contribution for each touch-point by dividing the score by the sum of scores of all assisting touch-points associated with the actual sale.

16. The method of claim 11, wherein the factor values are translated in a scale of 1 to n, n being e.g. 5.

17. The method of claim 16, wherein calculating the contribution of each touch-point further comprises calculating an assist contribution for each touch-point by dividing the score by the sum of scores of all assisting touch-points associated with the actual sale.
